(19) United States
(12) Patent Application Publication
(10) Pub. No.: US 2010/0310843 A1
(43) Pub. Date: Dec. 9, 2010

(54) DOUBLE-CAST SLUSH MOLDING COMPOSITIONS

(76) Inventors: William M. Humphrey, Dover, NH (US); Paul Drago, Rochester, NH (US); Daniel Durand, Berwick, ME (US)

Correspondence Address: FRASER CLEMENS MARTIN & MILLER LLC, 28366 KENSINGTON LANE, PERRYSBURG, OH, 43551, US

(21) Appl. No.: 12/519,941

(22) PCT Filed: Dec. 20, 2007
(86) PCT No.: PCT/US07/88420

§ 371 Date: May 12, 2010

Related U.S. Application Data
(60) Provisional application No. 60/871,123, filed on Dec. 20, 2006.

(51) Int. Cl. B32B 27/40; B32B 7/02; B29C 59/16; B28B 1/20

(52) U.S. Cl. 428/215; 428/423.3; 428/413; 264/447; 264/308

(57) ABSTRACT

A two layer material, and method for its manufacture, are disclosed, including an inner and an outer layer, the inner layer formed from an aliphatic urethane elastomeric composition as the layer exposed to view and to the environment and an aromatic urethane elastomer as the inner or backing layer. The layered material may be used to form a skin layer in an automotive air bag door. The layer material may be double cast from microspheres. The inner layer may be formulated to have good heat stability and flexibility, yet not include additives such as UV stabilizer as it may be positioned behind the outer protective layer.

### CROSS-REFERENCE TO RELATED APPLICATIONS

The present application claims the benefit of the filing date of U.S. Provisional Application Ser. No. 60/871,123, filed Dec. 20, 2006, the teachings of which are incorporated herein by reference.

### FIELD OF THE INVENTION

This invention relates generally to compositions for forming a shell or cover, and, more particularly, for slush molding a shell having a relatively more light resistant outer layer that may be provided from an aliphatic-based thermoplastic material and a relatively less light resistant inner or backing layer that may be formed from an aromatic-based material.

### BACKGROUND OF THE INVENTION

The prior art includes a number of different methods for forming thin, resilient multi-layer trim component shells such as automotive instrument panel skins. It is often desirable, particularly in automotive interior trim applications, for the exterior “class A” surfaces of such shells to have an appealing appearance and feel to automobile passenger compartment occupants. To provide an aesthetically pleasing outer (or class A) surface, at least the outer layer of such multi-layered shells may be formed by casting a powder or liquid. One such process is slush molding. Slush molding may involve casting a charge of polymer material against a heated mold surface that forms a desired shape and texture of the outer surface of the thin shell to be cast within the mold. The casting may be accomplished by attaching and sealing an open upper end of a charge box to an outer rim of an open end of the mold. The charge box may then be inverted to allow the polymer material within the charge box to fall by gravity from the charge box and onto the heated mold surface. Once polymer material has been applied to the heated mold surface, the charge box may return to its upright position and excess casting material returned to the charge box. The cast material may then be allowed to melt on the heated surface, the mold surface cooled, and the material allowed to harden before removing it from the mold surface.

Current slush molding methods may include a “double-cast” method that may include the casting of a first charge of polymer material on a heated mold surface as described above, then casting a second charge of polymer material on the inner surface of the layer formed by the first casting. Sufficient heat may be transferred from the heated mold surface through the first layer to melt the second charge layer. The mold surface may then be cooled to allow both layers to harden and bond to one another.

What therefore appears to be needed is a composition useful in a double cast slush molding method wherein the inner or backing layer may be of the same polymer family as the outer (show) layer (e.g. urethane) yet be of a lower relative cost. What also may be needed is a composition for slush molding a double-layer shell or skin using at least a proportion of less expensive materials without compromising the high-quality appearance and weatherability of an outer class-A surface of the shell or skin. Further, the composition of the inner layer may separately provide some enhanced properties to the shell, such as improved heat resistance.

### SUMMARY OF THE INVENTION

In accordance with this invention, a composition for molding a thin shell having an outer layer and an inner layer is provided that includes an aliphatic thermoplastic urethane outer layer and an aromatic urethane inner layer. The outer layer may provide the appearance (color, gloss and texture) and associated weathering resistance (e.g., to UV light) and the inner layer may provide a backing having other optimum performance capabilities, such as heat resistance (e.g., thermal aging resistance).

According to another aspect of the invention, a method for molding a thin shell having an aliphatic thermoplastic urethane outer layer and an aromatic urethane inner layer is provided. The method may include providing a mold having a mold surface configured to complement the desired shape of the shell to be molded and heating the mold surface. A first aliphatic thermoplastic urethane polymer material may then be provided in a first tub having a first tub opening and a second aromatic urethane polymer material may be provided in a second tub having a second tub opening. The second tub opening may be blocked and the tubs and the mold tipped until at least a portion of the first polymer material dispenses from the first tub onto the mold surface to form an outer layer. The tubs and the molds may then be then righted and the second tub opening unblocked while the first tub opening may be blocked. The tubs and the mold may then be tipped until at least a portion of the second polymer material dispenses from the second tub onto at least a portion of the outer layer to form an inner layer. The mold surface may then be then cooled, the inner and outer layers bonding together and the shell may be removed from the mold.

According to another aspect of the invention, a thin shell for an automotive trim panel having an outer aliphatic urethane layer and an inner aromatic urethane layer is disclosed. The inner layer may at least partially cover the inner surface of the outer layer and may be concealed from view of vehicle occupants. Taken together, the composite may provide a skin material of relatively low cost which may withstand air bag deployments at both high and low temperatures, both before and after heat aging.

According to another aspect of the invention, a thin shell for an automotive trim panel is disclosed, said shell having an outer aliphatic urethane layer and an inner aromatic urethane layer, at least a portion of the inner layer comprising a polymer material which comprised a formed article prior to its use as the inner layer. The inner layer may at least partially cover the inner surface of the outer layer and/or be concealed from view of the vehicle occupants. In addition, a portion of the inner layer may comprise regrind, reclaim or recycled skins from formed articles of a similar composition.

According to another aspect of the invention, a thin shell for an automotive trim panel is disclosed, the shell having an outer aliphatic urethane layer and an inner aromatic urethane layer. The inner layer material may comprise a polymer formulation which may be more susceptible to ultraviolet degradation than the outer layer, and the inner layer may at least partially cover the inner surface of the outer layer and be concealed from view of vehicle occupants.

According to another aspect of the invention, a thin shell for an automotive trim panel is disclosed having an outer aliphatic urethane layer and an inner aromatic urethane layer wherein the outer layer comprises an average thickness in a range between and including about 0.005 inches to about 0.025 inches.

According to another aspect of the invention, the compositions of the aliphatic outer layer and aromatic inner layer of the thin shell may include at least one common polyol component.

### DETAILED DESCRIPTION OF THE INVENTION

The present invention provides a skin or shell, particularly for automotive trim panels, and more particularly for air bag door applications, which may comprise two layers of urethane, an outer (class A or show) layer having relatively superior light stability and low temperature flexibility, and an inner (backing) layer comprising an aromatic urethane having a different optimized property variable, such as heat stability.

The outer layer may also comprise the reaction product of a polyol, chain extender and aliphatic organic diisocyanate. Reference to aliphatic herein, therefore to an aliphatic diisocyanate, is reference to a diisocyanate that contains, for example, only hydrocarbon functionality, for example, the use of an isocyanate such as hexamethylene diisocyanate or (HMDI). The outer layer is therefore one that may be formulated specifically to optimize weatherability, and as a consequence, it may preferably employ aliphatic functionality. The overall level of aliphatic functionality may therefore be greater than 75% (wt.) and fall within the range of 75-100% (wt). A completely (100% wt.) aliphatic polyurethane would therefore include a polyurethane that relies upon an aliphatic diisocyanate, an aliphatic polyol (e.g., aliphatic polyether or polyester) and an aliphatic chain extender. The aliphatic polyurethane so prepared may also be prepared in the presence of a urethane catalyst.

Accordingly, any suitable aliphatic organic diisocyanate, or mixture of diisocyanates, may be used in the elastomer forming process of the present invention. Representative examples of suitable organic diisocyanates may include, isophorone diisocyanate (IPDI), hexamethylene diisocyanate (HDI), hydrogenated MDI, hydrogenated XDI, cyclohexane diisocyanate, mixtures and derivatives thereof and the like. The aliphatic diisocyanates can be present in amounts ranging from about 20% to about 50% but are preferably present in amounts in the range of approximately 25% to 40% (by wt.).

The polyol reactants may include polyether polyols, polyester polyols and combinations thereof. Preferably the polyol may be of the type manufactured using an organometallic catalyst which results in a polyol having a level of terminal unsaturation of less than 0.04 meq/g, and preferably less than 0.02 meq/g. A representative example of such a polyol is Poly L 255-28 (sold by Arch Chemical) or Acclaim 4220N (from Bayer). Poly L 255-28 may comprise an ethylene oxide capped poly (propylene oxide) polyol with an approximate molecular weight of 4000 and a hydroxyl number of 28. The polyol component may be present in amounts ranging from approximately 40% to 70% (wt). The preferred concentration of polyol present in the reaction ranges between about 40% and about 60% (wt) and may be adjusted in this range to vary the hardness of the elastomer produced.

Chain extending agents which may be employed in the preparation of the urethane elastomer of the present invention may include secondary or aliphatic primary or secondary diamines (which would provide polyurea).

Specifically, chain extenders which may include ethylene glycol, diethylene glycol, propylene glycol, pentane diol, 3-methylpentane-1,5-diol, hexane diol, CHDM (1,4cyclohexanedimethanol), or HBPA (hydrogenated bisphenol A) may also be used.

In a preferred embodiment, the chain extender may be 1,4-butanediol. The chain extender, such as 1,4-butanediol, may be present in concentrations varying from about 6% to about 15% (wt), but preferably ranges from 7% to approximately 13% of the total formulation weight.

In addition, the outer layer may incorporate additives to further enhance weatherability, such as ultraviolet stabilizing agents, antioxidants, and pigments (see Table 1 for an exemplary formulation). In the context of the present invention, it is contemplated that the level of ultraviolet (UV) stabilizing agents may be present in an amount of at least about 0.25% (wt) based upon the entire formulation. More specifically, it is contemplated that the level of UV stabilizing agents may fall within the range of 0.25%-2.0% (wt.), including all values and increments therein.

The UV stabilizing agents may be understood to include a single UV stabilizer, or a mixture of stabilizers, such as a mixture of hindered amine light stabilizers (HALS) and hindered phenols as well as benzotriazole type compounds. One exemplary benzotriazole includes hydroxyphenol benzotriazole. With respect to the mixture of stabilizers, it is contemplated herein that one may utilize a mixture of HALS to hindered phenol, wherein the hindered amine to hindered phenol is present at a ratio of 1:1 to 2:1, including all values and increments therein. Accordingly, it may be appreciated that the HALS may be present at an excess to the hindered phenol compound.

The ultraviolet stabilizing agents may therefore specifically include a combination of a hindered amine light stabilizers (HALS) such as bis(1,2,2,6,6-pentamethyl-1-4-piperidinyl) sebacate (Chemical Abstract Number 41556-26-7, also known as Tinuvin 292 or 765 Ciba-Geigy Corp., Hawthorne, N.Y.) and a hydroxyphenyl benzotriazole such as a benzotriazole mixture of poly (oxy-1,2-ethanediyl), alpha-[3-[3-(2H-benzotriazol-2-yl)-5-(1,1-dimethylethyl)-4-hydroxyphenyl]-1-oxopropyl]-omega hydroxy- and poly(oxy-1,2-ethanediyl), alpha-[3-[3-(2H-benzotriazol-2-yl)-5-(1,1-dimethylethyl)-4-hydroxyphenyl]-1-oxopropyl)-omega-[3-[(2H-benzotriazol-2-yl)-5-(1,1-dimethylethyl)-4-hydroxyphenyl]-1-oxopropoxy)-, Chemical Abstract Number 104810-47-1 and polyethylene glycol with a molecular weight of 300 Chemical Abstract Number 25322-68-3 (also known as Tinuvin 1130 or 213 from Ciba-Geigy Corp., Hawthorne, N.Y.) and any other suitable ultra violet stabilizing agents.

In a related manner, the level of antioxidants may include a single antioxidant or a mixture of antioxidants. The antioxidants may be present at a level of at least about 0.40% (wt.). More specifically, the antioxidants may be present at a range of 0.40-0.80% (wt), including all values and increments therein. A particular preferred range includes 0.45-0.65% (wt).

Representative examples of antioxidants include Irganox 1010 [tetrakis (methylene(3,5-di-tert-butyl-4-hydroxycinnamate)] methane from Ciba-Geigy; Irganox 1076 [Octodecyl 3,5 di-tert-butyl-4-hydroxyhydrocinnamate] from Ciba-Geigy; Irganox 245 [Ethylenebis(oxyethylene)bis-(3-tert-butyl-4-hydroxy-5-thylhydrocinnamate)] from Ciba-Geigy; and Vanox 830 (a proprietary blend of a phenolic compound, alkylated diphenylamines and trialkyl phosphite from R. T. Vanderbilt).

Pigments may also be employed, which may be present at a concentration of at least about 1.0% (wt). More specifically, pigment concentration may be present at a concentration of between about 1.5% (wt) to about 3.0% (wt). It can be appreciated that the use of pigment may be controlled within such levels to enhance, e.g., UV stability without adversely influencing other mechanical properties, such as tensile strength, elongation, etc.

Any suitable pigmenting agent or mixture of pigmenting agents may be used in the elastomer forming process of the present invention. The agent or agents may have long-term ultraviolet light resistance for Arizona exposure and may also include heat resistance up to 260° C. (500° F.). Such resistance may provide resistance to weathering as well as the ability to survive the dry casting process and the extrusion compounding process, and control any significant degradation of the urethane elastomer.

Representative pigments include carbon black (Columbian Chemicals Corporation); titanium dioxide (DuPont Company, Chemicals Department); Chomophthal Red BPP (Ciba-Geigy, Pigments Division); Phthalocyanine Blue Red Shade (Ciba-Geigy, Pigments Divisions); Yellow Iron Oxide (Miles Incorporated, Organic Products Division); and Quinacridone Violet (Hoechst Celanese Corporation, Specialty Products Group-Pigments). The pigments may be dispersed in a carrier material for ease of dispersion in the polymer formulation, for instance, FP74-45 in Table 1 is a 45% (wt.) dispersion of a gray pigment in a clear version of the polyol formulation of Table 1.

The combination of an aliphatic polyurethane, along with the additives selected from one or more of a UV stabilizer, an antioxidant and a pigment, are selected such that the polyurethane is provided and may form a first layer having a DE≦3.0 after 2450 kJ of Xenon arc exposure. Such control of color change therefore provides obvious advantages in such applications as a vehicular application wherein the exposed first layer may experience relatively high levels of exposure to sunlight. For example, it has been found that by utilizing all three of the additives (UV stabilizer, antioxidant and pigment) within the above referenced concentration levels, the first layer provides the indicated DE performance value.

The urethane catalysts which are useful in the present invention may be any suitable urethane catalyst, or mixture of urethane catalysts, that may be used in the elastomer forming process of the present invention. Representative samples include (a) tertiary amines such as ZF-20 [bis 2-(N,N-dimethylamino)ether] from Huntsman Chemical; N-methylmorpholine from Huntsman Chemical; N-ethylmorpholine from Huntsman Chemical; DMEA N,N-dimethylethanolamine from Union Carbide; Dabco 1,4-diazbicyclo[2,2,2] octane from Air Products and the like; (b) salts of organic acids with a variety of metals such as alkali metals, alkaline earth metals, Al, Sn, Pb, Mn, Co., Ni, and Cu, including, for example, sodium acetate, potassium laurate, calcium hexanoate, stannous acetate, and stannous octoate, and the like; (c) organometallic derivatives of tetravalent tin, trivalent and pentavalent As, Sb, and Bi, and metal carbonyls of iron and cobalt. Useful organotin compounds include dialkyltin salts of carboxylic acids, e.g., dibutyltin diacetate, dibutyltin dilaurate, dibutyltin maleate, dilauryltin diacetate, dioctyltin diacetate and the like. Preferred catalysts are BiCat 8, BiCat 12, BiCat V and Coscat 83. The BiCat materials are products of Shepherd Chemical. Coscat 83 is a product of CasChem. Corporation. BiCats 8 and 12 are mixtures of bismuth and zinc carboxylates. These catalysts may be present at a total concentration in the range of approximately 0.1% to 0.3% by weight, and preferably in the range of approximately 0.15% to 0.25%.

More particularly, the outer layer may comprise a light stable polyether polyol-based aliphatic urethane thermoplastic elastomer as shown in the Examples which appear below.

The inner layer of the skin or shell of the present invention may be primarily aromatic based. That is, an aromatic polyurethane type inner layer which should be understood herein as utilizing an aromatic diisocyanate and/or the use of an aromatic diisocyanate along with an aromatic extender. However, in either case, such aromatic polyurethane may utilize a polyol, including an aliphatic polyol (e.g., aliphatic polyether or aliphatic polyester). Accordingly, it can be appreciated that the use of an aromatic diisocyanate or even an aromatic extender is one in which the aromaticity may serve to increase a physical property such as heat resistance. The aromatic based inner layer may therefore be one that has a DE>3.0 after 2450 kJ of Xenon arc exposure. The aromatic polyurethane so prepared may also be prepared in the presence of a urethane catalyst.

Accordingly, the inner layer may comprise a base polyol component similar to that used in the formulation for the outer layer together with a relatively lower cost aromatic isocyanate such as diphenylmethane diisocyanate. A cycloaliphatic (secondary) amine may be added to provide urea linkages and improve the retention of physical properties after heat aging (see the Examples which follow). In addition, a reduced stoichiometric amount (e.g., a relatively low isocyanate index of 0.95-0.99) of the aromatic isocyanate may be used to reduce the glass transition temperature (Tg) of the inner layer. A low fogging catalyst may also be used, however no pigment or antioxidants or ultraviolet light absorbers may be needed as the inner layer may not be exposed to sunlight.

It is contemplated that the inner layer may comprise a formulation including a mixture of both aliphatic and aromatic isocyanates.

The thermoplastic elastomers described above may be formed into castable powders and double cast slush molded according to the teachings of U.S. Pat. Nos. 6,409,493 and 6,709,619, which are assigned to the assignee of the present invention and included herein by reference in their entirety.

In accordance with another aspect of the invention, microspheres formed in the size range of about 0.007″ to about 0.040″ from the compositions described above may be suitable for use in slush molding. The microspheres may be formed in accordance with U.S. Pat. Nos. 5,525,274; 5,525,284; 5,597,586; 5,654,102; 5,998,030 and 6,410,141, which are commonly assigned to the assignee of the present invention and included herein by reference in their entirety. It is also contemplated that particles of the urethane formulations which will be cast to form the outer and inner layers may be produced by other means, such as, but not limited to, cryogenic grinding and pelletizing.

In practice, a thin shell having an outer layer and an inner layer may be formed by first providing a mold with a mold surface configured to complement the desired shape of the shell to be molded. The mold surface may then be heated (via suitable heaters such as the hot oil heater of U.S. Pat. No. 4,389,177, electrical heaters as disclosed in U.S. Pat. No. 4,979,888, hot air heating according to U.S. Pat. No. 4,623,503 or infrared heating according to U.S. application Ser. Nos. 10/433,361 and 10/641,997). The casting surface may then be heated to cause the thermoplastic melt extruded microspheres (particles, pellets, etc.) of the aliphatic urethane composition to melt as they are flowed evenly across the casting surface and compacted thereon by the static head of the overlying material. It has been found that this enables a wider range of particle sizes to be used for build-up of a uniform thickness shell on the casting surface having low porosity that may be below a visual threshold for holes in the skin.

This layer is termed the “outer” layer because it may, when installed, be the outer class A surface of a trim panel, subject to the possible additional application of an outer coating (e.g. paint, clearcoat). The aromatic urethane composition, also preferably in the form of a dry particulate, such as powder or microspheres, may be cast on the inner surface of the outer layer formed of the first aliphatic urethane material. The aromatic urethane material may be allowed to melt and form an inner layer at least partially, and preferably completely, covering the inner surface of the outer layer. Sufficient heat may be transferred from the heated mold surface through the outer layer to melt the inner layer. The mold surface may then be cooled or allowed to cool which may allow the inner and outer layers to harden and bond together. Finally, the shell may be removed from the mold.

### EXAMPLES

Table 1 illustrates 3 exemplary aliphatic thermoplastic urethane elastomer compositions suitable as the outer layer according to the present invention.

TABLE 1
ALIPHATIC LAYER

| INGREDIENT | “SOFT” | “MEDIUM” | “HARD” |
|---|---|---|---|
| L255-28 or equivalent | 59.19 | 48.66 | 41.31 |
| 1,4BDO | 7.81 | 10.7 | 12.71 |
| TINUVIN 765 | 1.34 | 1.34 | 1.34 |
| TINUVIN 1130 | 0.66 | 0.66 | 0.66 |
| IRGANOX 1010 | 0.45 | 0.45 | 0.45 |
| BiCAT V | 0.2 | 0.2 | 0.2 |
| GRAY FP 75-45 | 4.42 | 4.42 | 4.42 |
| VPG 1732 [mold release] | 0.1 | 0.1 | 0.1 |
| TOTAL | 73.82 | 66.18 | 60.84 |
| DES W | 26.18 | 33.82 | 39.16 |
| TOTAL | 100 | 100 | 100 |

Table 2 illustrates an exemplary aromatic urethane elastomer composition employing a similar polyol component to the aliphatic composition of Table 1 but substituting an aromatic iscocyanate (MDI) for the aliphatic (Des W). In addition, only a secondary amine, Jefflink 754 (from Huntsman Chemical), and a low fogging catalyst, (bismuth octoate, 16%, from Shepherd Chemical), are included in the formulation.

TABLE 2
AROMATIC LAYER

| INGREDIENT | |
|---|---|
| L255-28 | 70.03 |
| 1,4BDO | 6.08 |
| JEFFLINK 54 | 1.33 |
| BiOCT (16%) | 0.23 |
| TOTAL | 77.67 |
| MDI | 22.33 |
| TOTAL | 100 |

Inclusion of the secondary amine may provide urea linkages to improve the retention of physical properties after heat aging (such as after 500 hours at 120° C.). The aromatic isocyanate may further provide a substantial reduction in cost of the urethane elastomer over the aliphatic used in the outer layer. By formulating to a reduced stoichiometric ratio (isocyanate index of about 0.90 to about 100.0), the glass transition temperature of the resulting aromatic elastomer may be reduced. This may provide increased elongation at low temperature and may result in reduced fragmentation of the skin during air bag deployments at low temperature (for instance, at −30° C.). The use of a secondary amine to form urea linkages may provide improved hear resistance such that air bag deployments at −40° C. after heat aging may be performed without significant skin fragmentation. Soy lecithin may be included to aid in melt processing of the composition.

No additional expensive additives, such as ultraviolet light absorbers, heat stabilizers, antioxidants or even pigments may be needed in the inner layer, as it may be hidden from view and exposure by the outer layer, further reducing the cost of the composition.

When molded, the outer aliphatic layer may be cast to a thickness of at least about 0.005 inches. More specifically, it may have a thickness between and including about 0.005 inches to about 0.025 inches. The inner layer may be cast to provide a total thickness of shell or skin of at least about 0.025 inches. More specifically, the inner layer may have a thickness between and including about 0.025 to about 0.050 inches. Any weakening of the skin to aid in air bag deployment may include scoring or slicing of the inner layer and only partial slicing, if necessary, of the outer layer.

Since the compositions of the inner and outer layer may be chemically similar (i.e. they may be both urethane or urea type functionality) generally good adhesion between the layers may be obtained. In addition, the layer may also provide good adhesion to any subsequent urethane foam layer provided therebehind.

As a further feature of the invention, the inner layer may comprise a polymer material at least a portion of which comprised a formed article prior to its use as the second polymer material. By formed article, it is meant to include polymer material that has, e.g., experienced a prior plastics manufacturing operation, such as slush molding or injection molding, wherein the plastic material has been converted, by heat, or by heat and pressure, into some desired shape, but which has not survived a quality control measure, and has been rejected by the manufacturer for commercial release. This would also include materials recovered in manufacture such as trim scrap and faulty parts (a/k/a/regrind or recycle), and materials recovered from discarded post-consumer products (a/k/a/reclaim). A formed article may not include virgin material (i.e., that has not been subjected to use other than required for its original manufacture). Preferably, the formed article used as a portion of the composition of the inner layer comprises a common polymer chemistry, for instance urethane, to assure compatibility.

It is further contemplated that the inner layer may comprise mixtures of previously formed articles, recycled polymers, reclaimed polymers, formulations including mixtures of aliphatic and aromatic diisocyanates and mixtures thereof.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that the invention may be practiced otherwise than as specifically described.

1. A two-layer material comprising:
a first layer comprising an aliphatic based polymer material having a DE≦3.0 after 2450 kJ of Xenon arc exposure; and
a second layer comprising an aromatic based polymer material having a DE>3.0 after 2450 kJ of Xenon arc exposure.

2. The two layer material of claim 1 wherein said first layer has a thickness between about 0.005-0.025 inches and said second layer has a thickness between about 0.025-0.050 inches.

3. The two layer material of claim 2 wherein said first layer has a DE≦3.0 after 2450 kJ of Xenon are exposure and has a cold flexibility characterized by avoiding cracking under the following conditions:
a 180 degree bend at −20° C. over a 20 mm diameter mandrel at a specimen size of about 50×150 mm.

4. The two layer material of claim 1 wherein said first layer has an ultimate elongation to break of at least about 100% both before and after 500 hours of heat aging at 120° C.

5. The two layer material of claim 1 wherein said first layer comprises an aliphatic based polymer material that includes one or a plurality of UV stabilizers.

6. The two layer material of claim 5 wherein said one or a plurality of UV stabilizers are present at a concentration of at least about 0.25% (wt).

7. The two layer material of claim 5 wherein said UV stabilizers comprise a hindered amine light stabilizer and a hindered phenol light stabilizer.

8. The two layer material of claim 7 wherein said hindered amine light stabilizer and said hinder phenol light stabilizer are present at a ratio of about 1:1 to 2:1.

9. The two layer material of claim 1 wherein said aliphatic based polymer material includes an antioxidant.

10. The two layer material of claim 9 wherein said antioxidant is present at a level of at least about 0.40% based on total formulation weight.

11. The two layer material of claim 1 wherein said aliphatic based polymer material includes a pigment.

12. The two layer material of claim 11 wherein said pigment is present at a concentration of at least about 1.0% based on total formulation weight.

13. (canceled)

14. The two layer material of claim 1 wherein said aliphatic based material contains a polyol with end group unstaturation of less than about 0.04 meq/g.

15. The two layer material of claim 1 wherein said aliphatic based material contains a polyol containing propylene oxide and ethylene oxide at a number average molecular weight (Mn) of about 2500-6000.

16. The two layer material of claim 1 wherein said second layer comprises one or a combination of recycled polymer, reclaimed polymer, a previously formed article and a mixture of aliphatic and aromatic based polymer materials.

17. The two layer material of claim 1 wherein said aromatic based polymer material includes a cycloaliphatic amine extender.

18. (canceled)

19. A method for molding a thin shell having an aliphatic urethane outer layer and an aromatic urethane inner layer, the method including the steps of: providing a mold having a mold surface configured to complement the desired shape of the shell to be molded; heating the mold surface; providing a first aliphatic urethane material in a first tub having a first tub opening; providing a second aromatic urethane material in a second tub having a second tub opening; blocking the second tub opening; tipping the tubs and the mold until at least a portion of the first aliphatic urethane material dispenses from the first tub onto the mold surface to form an outer layer; righting the tubs and the mold; blocking the first tub opening; opening the second tub opening; tipping the tubs and the mold until at least a portion of the second aromatic urethane material dispenses from the second tub onto at least a portion of the outer layer to form an inner layer; cooling the mold surface; allowing the inner and outer layers to bond together; and removing the shell from the mold.

20. The method of claim 19 wherein said aliphatic urethane provides a DE≦3.0 after 2450 kJ of Xenon arc exposure and said aromatic urethane provides a DE>3.0 after 2450 kJ of Xenon arc exposure.

21. The method of claim 19 wherein one or both of said aliphatic urethane outer layer and said aromatic urethane inner layer are formed from polymeric microspheres having an outer diameter in the range of about 0.007 to about 0.040 inches.

22. The method of claim 19 wherein said aromatic urethane layer comprises a polymer a portion of which once comprised a formed article.
